(19) United States
(12) Patent Application Publication
(10) Pub. No.: US 2017/0089058 A1
(43) Pub. Date: Mar. 30, 2017

(54) METHOD OF CLAMPING TO A STRUT CHANNEL

(71) Applicant: Steven A. Roth, Alamo, CA (US)

(72) Inventor: Steven A. Roth, Alamo, CA (US)

(21) Appl. No.: 15/278,755

(22) Filed: Sep. 28, 2016

Related U.S. Application Data
(60) Provisional application No. 62/234,163, filed on Sep. 29, 2015.
(60) Provisional application No. 62/364,627, filed on Jul. 20, 2016.

(51) Int. Cl. E04B 1/18; F16B 2/06; F16M 13/02; E04B 1/19; F16L 3/22

(52) U.S. Cl. CPC E04B 1/185; E04B 1/1903; F16L 3/22; F16M 13/02; F16B 2/065; E04B 2001/1924; E04B 2001/1936; E04B 2001/1942

(57) ABSTRACT

A clamp is disclosed along with method of using the clamp attach or more or more strut channels to another element, which may be a flange, such as the flange of an I-beam or another strut. The clamp has an opening to accept the strut channel between a pair of sides and against the bottom of the clamp, and a pair of clamp surfaces for contacting the other element. A threaded element is provided for forcing the strut channels against the other element. A method for using the clamp allows the clamp to be placed anywhere on the strut channel and allow an installer to tighten the clamp from either above or below the clamp.

### CROSS-REFERENCE TO RELATED APPLICATIONS

This application claims the benefit of U.S. Provisional Application No. 62/234,163, filed Sep. 29, 2015, and U.S. Provisional Application No. 62/364,627, filed Jul. 20, 2016, which are hereby incorporated by reference in their entirety.

### BACKGROUND OF THE INVENTION

### Field of the Invention

The present invention generally relates to building construction and more specifically to a method for elements from buildings, such as attaching strut channels to I-beams or to other strut channels.

### BRIEF SUMMARY OF THE INVENTION

During the construction of buildings, it is common to attach strut channels to beams which form structural comports of a building. Thus, for example, strut channels may be used in the construction and electrical industries for light structural support, often for supporting wiring, plumbing, or mechanical components such as air conditioning or ventilation systems.

FIG. 1, for example, is a perspective prior art view of a clamp 30 used to attach a strut channel 20 to a beam 10. Beam 10 includes a flange 11 and clamp 30 includes a plate 33, and a u-shaped rod 31, with threaded ends and a pair of nuts 35. Clamp 30 holds one side of strut 20 held against the bottom of flange 11, with the other three sides of the strut surrounded by u-shaped rod 31. Plate 33 is positioned on the top side of flange 11 and has a pair of holes through which ends of u-shaped rod 31 protrude. When nuts 35 are threaded onto the ends of the u-shaped rod, strut 20 is pulled towards the bottom of flange 11 and plate 33 is forced down on to the top of flange.

FIG. 2 is a perspective view of a prior art strut channel 20. Strut channel 20 is part of a standardized formed structural system that is defined by the Metal Framing Manufactures Association (Chicago, Ill.), and described in the document which is available at http://www.metalframingmfg.org/MFMA%202004%20Standards.doc. Strut channel 20 is also referred to as a strut, and is commercially available from a number of companies, such as an not limited to, UNISTRUT® (Unistrut Corp., Harvey, Ill.), POWER-STRUT® (Atcor International, Harvey, Ill.), and SUPERSTRUT® (Thomas & Betts, Memphis, Tenn.).

Strut channel 20 is formed from a sheet of material to have an outer surface 27 and an inner surface 28 that faces an interior 29. More specifically, the material is formed to have a back 21 and front 23, with width Y, and a pair of sides 22 with height Z. Back 21 and pair of sides 22 are generally solid, though in some embodiments they may have cut-outs. Front 23 includes solid portions 24 that terminate in lips 25 that form an opening 26 of width X which provides access from the exterior of strut channel 20 to interior 29.

Strut channel 20 may be formed, for example and without limitation, from 12 gauge, 14 gauge, 15 gauge, or 19 gauge metal, such as a low-carbon strip steel. In certain embodiments, the cross section of strut channel 20 is square, with dimensions Y and Z approximately the same and being, for example and without limitation, from 3/16 inches to 2 inches, and may have dimensions, for example, of Y=Z= 3/16 inches, 1¼ inches, 1½ inches, or 1⅝ inches. The dimension X is less than the width Y, and may be from X= 7/16 inches to X=⅞ inches. In other embodiments, strut channel 20 is rectangular and may, for example and without limitation, have dimensions Y=1⅝ inches, with Z=⅞ inches or Z=3¼ inches.

Clamp 30 is just one of several types of clamps that are used to support a strut channel from a flange on the underside of beam. The clamps used for such purposes have different designs but generally work by the application of an upwards force along an entire bottom side of the strut channel to push it against the flange, and a fastening mechanism that is operated from the top side of the flange. Other types of clamps support the strut channel from a threaded piece placed in the open end of the strut and which sit against the inner portion of lips 25.

While the use of prior art clamps is effective, there are several problems using them. Prior art clamps may be difficult to use. For example, when suspending strut channels below an I-beam, a worker must get above the bottom of the I-beam to tighten the clamp. Other prior art clamps must be attached from the end of struts, making their use for attaching additional components difficult.

Thus there is a need in the art for an improved method of clamping components, The method should be easy to execute with putting undue strain on the installer, should allow for attachment of components without disassembly what has been previously constructed, and should be cost effecting.

### BRIEF SUMMARY OF THE INVENTION

The present invention overcomes the disadvantages of prior art by providing a clamp with a clamp body with an opening that can accept a strut channel and a pair of notches that can accept the edge of a flange of an I-beam or another strut channel, and a threaded element to force the accepted parts together.

It is one aspect to provide a method of clamping one or more parallel strut channels to an element with a clamp. The element is a rigid element having a first element side and a second element side parallel to the first element side. The clamp includes a clamp bottom at a proximal end of the clamp including a threaded aperture sized to accept a threaded element having a head at a proximal end for tightening the threaded element and a surface at the distal end, a first clamp side extending from the clamp bottom to a distal end of the clamp, and a second clamp side extending from the clamp bottom to the distal end. The first clamp side and the second clamp side are planar and parallel with a spacing, the first clamp side has a first notch with a first clamp surface through the thickness of the first side, and the second clamp side has a second notch with a second clamp surface through the thickness of the second clamp side. The first clamp surface and the second clamp surface are coplanar and parallel to the bottom. The method includes accepting the one or more parallel strut channels in the clamp, where the one or more parallel strut channels are positioned against the clamp bottom and between the first clamp side and the second clamp side; placing the first clamp surface and the second clamp surface against the first element side with the accepted one or more parallel strut channels adjacent the second element side; and tightening the threaded element such that the distal end of the threaded element contacts the accepted one or more parallel strut channels. The clamp provides a force on the one or more parallel strut channels to clamp the one or more parallel strut channels to the element.

It is another aspect to provide that the one or more parallel strut channels is one strut channel having a rectangular cross section with a strut back, a pair of strut sides and a strut top having an opening to an interior of the one strut channel, where the strut back has an inner surface facing the interior of the one strut channel. The placing places the one strut channel in the clamp includes placing the strut back against the clamp bottom. The tightening tightens the threaded element provides a force to the inner surface of the strut back.

It is yet another aspect to provide that the one or more parallel strut channels is one strut channel having a rectangular cross section with a strut back, a pair of strut sides and a strut top, that the placing places the one strut channel in the clamp includes placing the strut top against the clamp bottom, and the tightening tightens the threaded element provides a force to an outer surface of the strut back.

It is one aspect to provide that the distal end of the threaded element includes an enlarged surface area to provide the force on the one or more parallel strut channels when the threaded element is tightened.

It is another aspect to provide that the distal end of the threaded element contacts a separate element to provide the force on the one or more parallel strut channels when the threaded element is tightened.

In various embodiments, it is an aspect that the element is a flange, the flange of an I-beam, that is has a rectangular shaped cross-section, a square shaped cross-section, or is an angle shaped member.

In various other embodiments, it is an aspect that the least one strut channel of the one or more parallel strut channels has a rectangular cross-sectional shape.

It yet other various embodiments, it is an aspect that the one or more parallel strut channels is one strut channel, or is two strut channels.

It is thus seen that various embodiments provide a clamp that is useful for clamping, for example, channels to flanges. The clamp can be used for a variety of channel and flange sizes, and can be used to clamp channels and flanges in a variety of orientations.

These features together with the various ancillary provisions and features which will become apparent to those skilled in the art from the following detailed description, are attained by the method of clamping of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a perspective view of a prior art clamp used to attach a strut channel to a beam.

FIG. 2 is a perspective view of a one type of prior art strut channel;

FIGS. 3 and 4 are a side and back view, respectively, of first configuration for using a clamp;

FIGS. 5A, 5B, 5C, and 5D are a top view, front view, side view, and back view, respectively, of a first embodiment clamp body;

FIGS. 6A and 6B are a side and top view, respectively of a second embodiment threaded member,

FIG. 6C is a back view of the use of the second embodiment threaded member;

FIGS. 7A, 7B, and 7C are a back, side, and top view, respectively, of a third embodiment threaded member;

FIG. 7D is a back view of the use of the third embodiment threaded member;

FIGS. 8 and 9 are a side and back view, respectively, of a second configuration for using a clamp;

FIG. 10A is a back view of a first alternative clamp body;

FIGS. 10B, 10C, 10D, and 10E illustrate first, second, third, and fourth alternative notches, respectively.

FIGS. 11-13 illustrate alternative embodiments for clamping to a pair of I-beams, where FIG. 11 clamps along facing flanges, FIG. 12 clamps along opposing flanges, and FIG. 13 clamps on all flanges;

FIG. 14 illustrates and embodiment of the use of the inventive clamp, where the strut channel is clamped to the top of a pair of I-beam flanges;

FIGS. 15A and 15B are a side view and back view, respectively, which illustrates an alternative clamp embodiment for accepting a pair of strut channels within the clamp body;

FIG. 16 is a side view of another alternative clamp embodiment which includes a lip to secure an accepted channel;

FIG. 17 is side view of various uses and combinations of the inventive clamps;

FIG. 18 is a side view of another configuration of inventive clamps; and

FIGS. 19A and 19B are a side view and end view, respectively, of yet another configuration of the inventive clamps.

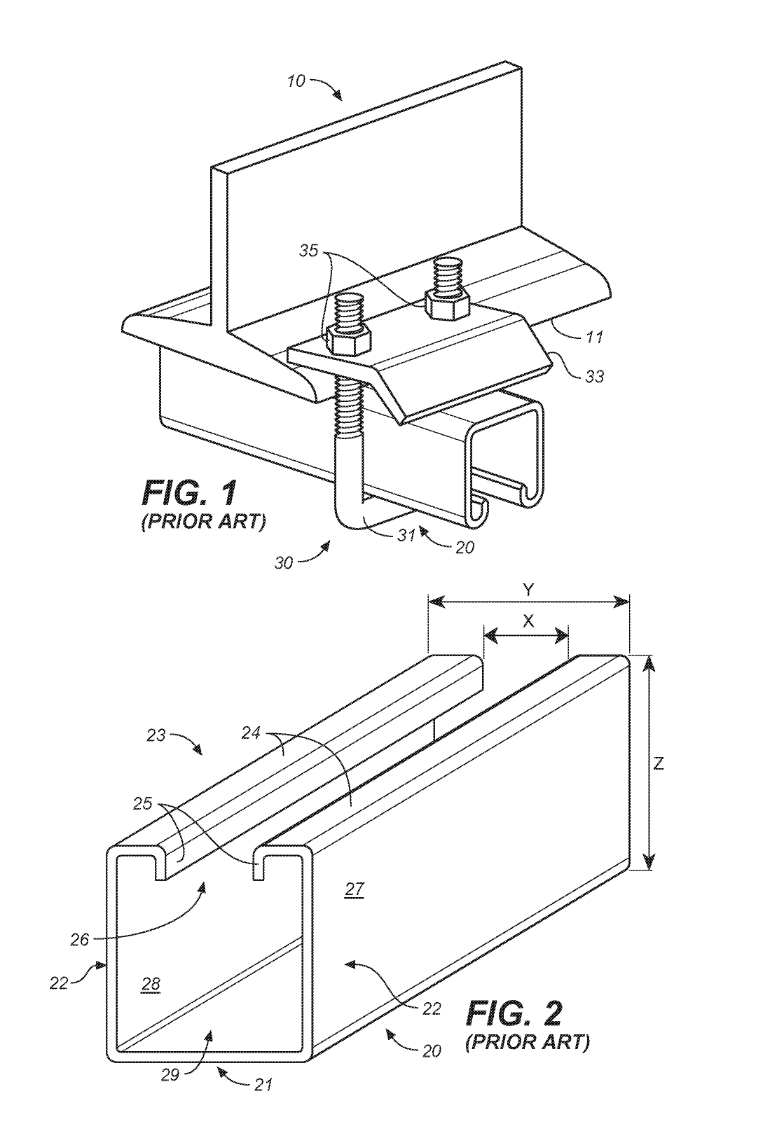

Reference symbols are used in the Figures to indicate certain components, aspects or features shown therein, with reference symbols common to more than one Figure indicating like components, aspects or features shown therein.

### DETAILED DESCRIPTION OF THE INVENTION

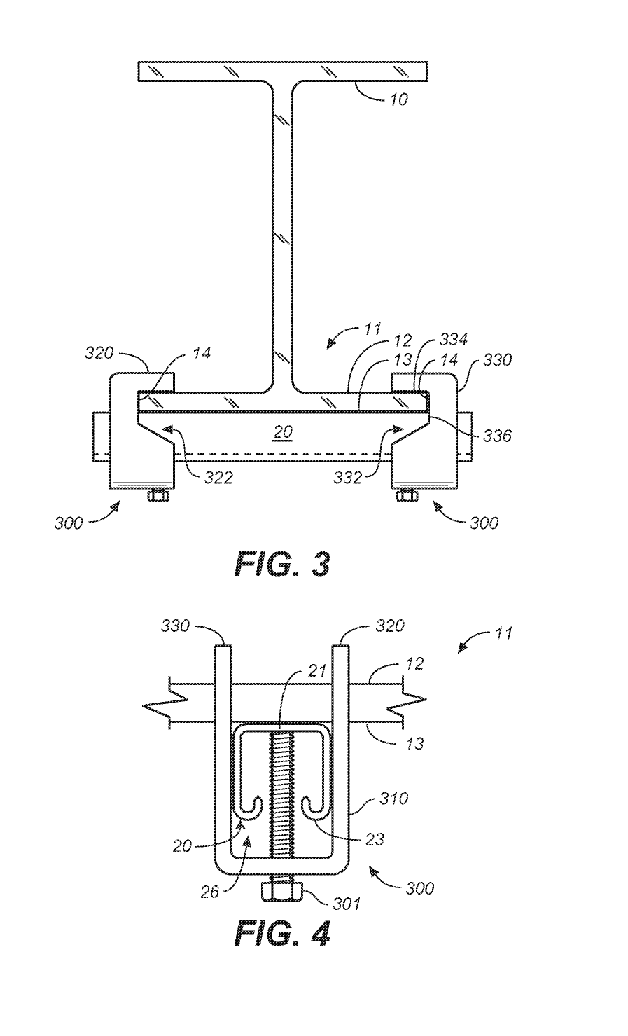

A first embodiment clamp 300 is shown in FIGS. 3 and 4, which are a side and back view, respectively, of a pair of first embodiment clamps used to attach strut channel 20 to flange 11 of I-beam 10, where flange 11 has a top surface 12, a bottom surface 13, and an edge 14. The use of clamp 300 for attaching strut 20 to flange 11 is illustrative and, as illustrated subsequently, clamping may require only one clamp, and the clamp may be used for clamping a variety of elements together, such as one or more struts, an angle, or a tube, to other struts, or to another type of flange or to an angle bracket. While clamp 300 has been described as clamping a strut channel, as described above, it will be appreciated that the inventive clamp is not limited to the strut channels mentioned above, but can also work with strut channels of other dimensions.

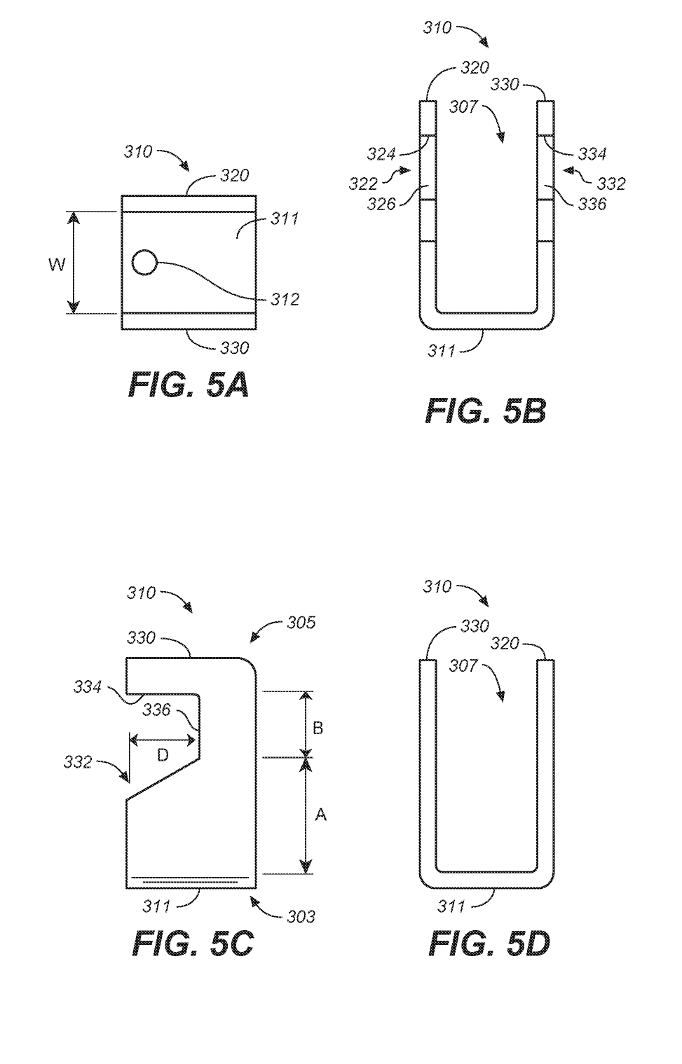

Clamp 300 includes a clamp body 310 which is shown in more detail in FIGS. 5A, 5B, 5C, and 5D, as a top, front, side, and back view, respectively. Clamp body 310 has a bottom 311 at a proximal end 303, and a first side 320 and a second side 330 that extends from the bottom to distal end 305 and which form an opening 307. Bottom 311 has a threaded hole 312, as shown in FIGS. 4 and FIG. 5A, for accepting a threaded element 301, which may be, for example and without limitation, a rod or a bolt. As is best viewed in FIGS. 3 and 5B, first side 320 has a notch 322 with a depth D and which includes a first clamp surface 324 and a back 326 of length B. As is best viewed in FIGS. 5B and 5C, second side 330 includes has a notch 332 which also as a depth D, and which has a first clamp surface 334 and a back 336. Clamp surfaces 324 and 334 are co-planar and parallel to bottom 311, with a spacing A.

Various elements maybe clamped depending on the dimensions A, B, and H. Thus, for example, a larger B allows for notches 322 and 332 accepting a thicker flange, a larger H allows for accepting a wider dimension strut channel, a larger B allows for accepting a taller channel, such as a pair of channels joined lengthwise.

Clamp body 310, in various alternatives, is sized to accept strut channels having square cross-sectional areas, rectangular cross-sectional areas, or to accept two or more strut channels that are joined or placed longitudinally in the clamp body. In certain embodiments, the dimension W (as shown in FIG. 5A) may be sized to accept the width of a standard strut channel, the dimension B (as shown in FIG. 5C) may be sized to accept the height of an I-beam flange, and the dimension A (as shown in FIG. 5C) may be sized to accept one or more strut channels and the I-beam flange.

Clamp body 310 is generally “U-Shaped,” with an opening 307 between sides 320 and 330, and with a bottom 311. Clamp 300 may be used to support a strut channel 20 on a flange, for example, as shown in FIGS. 3 and 4, by placing with notches 322 and 332 over flange 11 with clamp surfaces 324 and 334 against the top surface 12 of flange 11 and edge 14 in contact with backs 326 and 336, and with strut channel 20 positioned below the bottom surface 13 of flange 11. In FIGS. 3 and 4, strut channel 20 is oriented with back 21 against flange 11. Threaded element 301 thus passes through opening 26 of strut channel and is then tightened against an inner surface of back 21, pushing the strut channel against flange 11.

Because of clamp body 310 has an opening 307, the clamp body may be easily placed at any location on a strut channel without disturbing or removing any other components which may be attached to the strut channel. In addition, the orientation of installation of FIG. 3 allows for tightening of clamp 300 from below, since threaded element 301 protrudes downwards from I-beam 10. This is an advantage for overhead installation of the clamp.

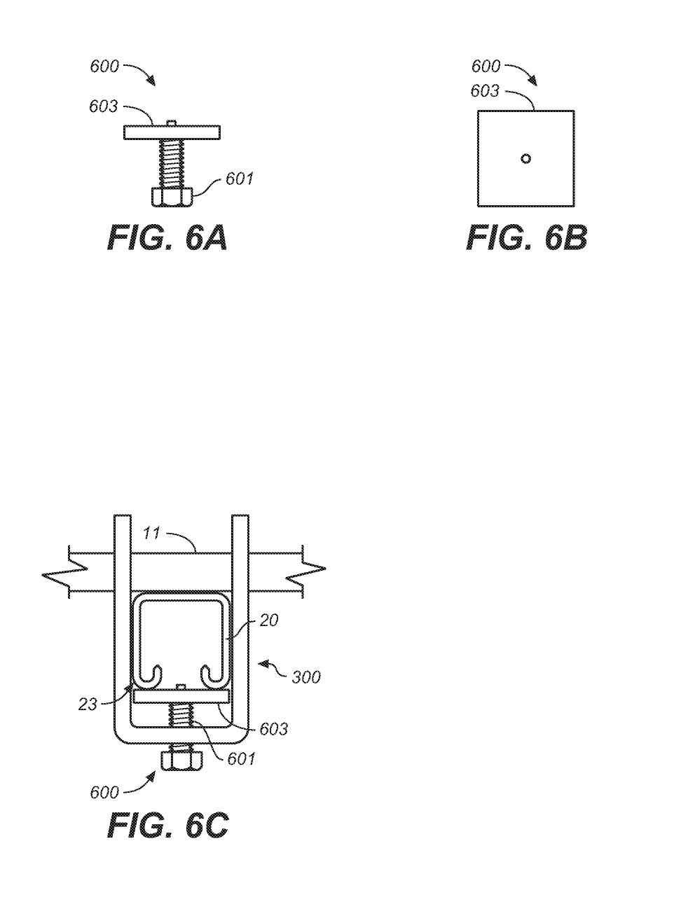

FIGS. 6A and 6B are a side and top view, respectively of a second embodiment threaded element 600, and FIG. 6C is a back view of the use of the second embodiment threaded element. Threaded element 600 is generally similar to threaded element 301, except where explicitly noted.

Threaded element 600 includes a bolt 601 and a clamp surface 603. As shown in FIG. 6C, when bolt 601 is tightened, clamp surface 603 contacts strut channel 20, providing a force over a larger area that does threaded element 301. In addition, for the orientation of strut channel 20 illustrated with the strut channel is oriented with back 21 against flange 11, clamp surface 603 contacts front 23 of the strut channel instead of passing through the strut channel, as shown in FIG. 4.

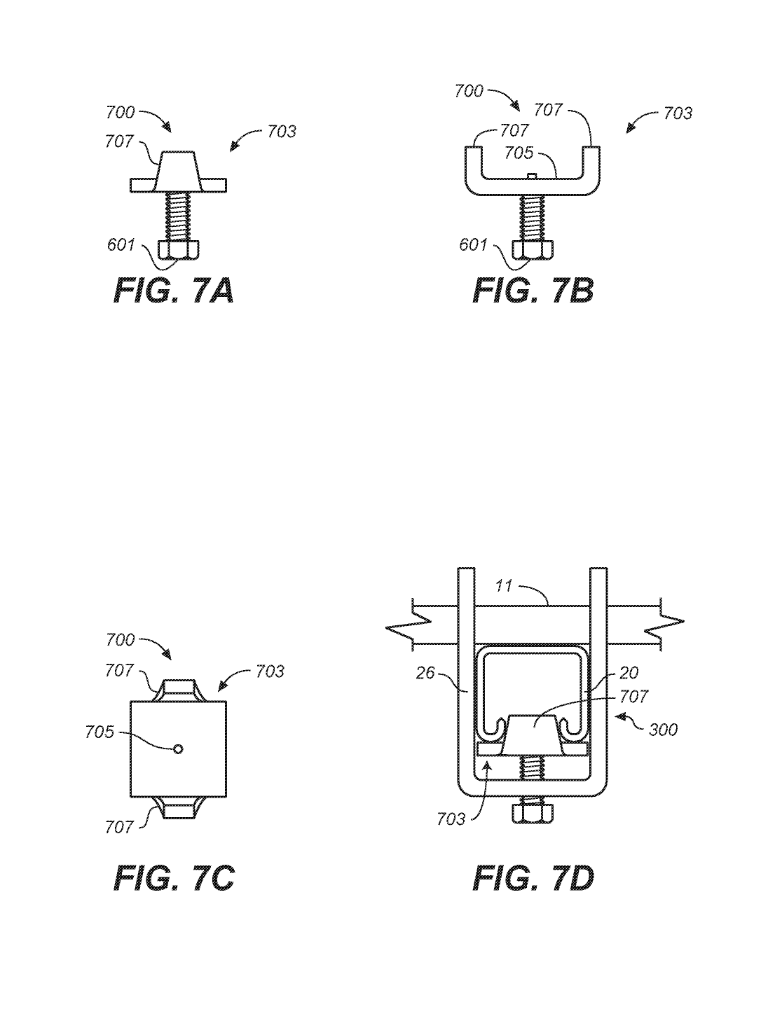

FIGS. 7A, 7B, and 7C are a back, side, and top view, respectively, of a third embodiment threaded member 700, and FIG. 7D is a back view of the use of the third embodiment threaded member. Threaded element 700 is generally similar to threaded element 600, except where explicitly noted.

Threaded element 700 includes bolt 601 and a clamp surface 703 which as a planar portion 705 and a pair of tabs 707. For the orientation of strut channel 20 illustrated, planar portion 705 contacts front 23 of the strut channel, while tabs 707 extend into opening 26, and act to keep the clamp aligned with the strut channel as the bolt is tightened.

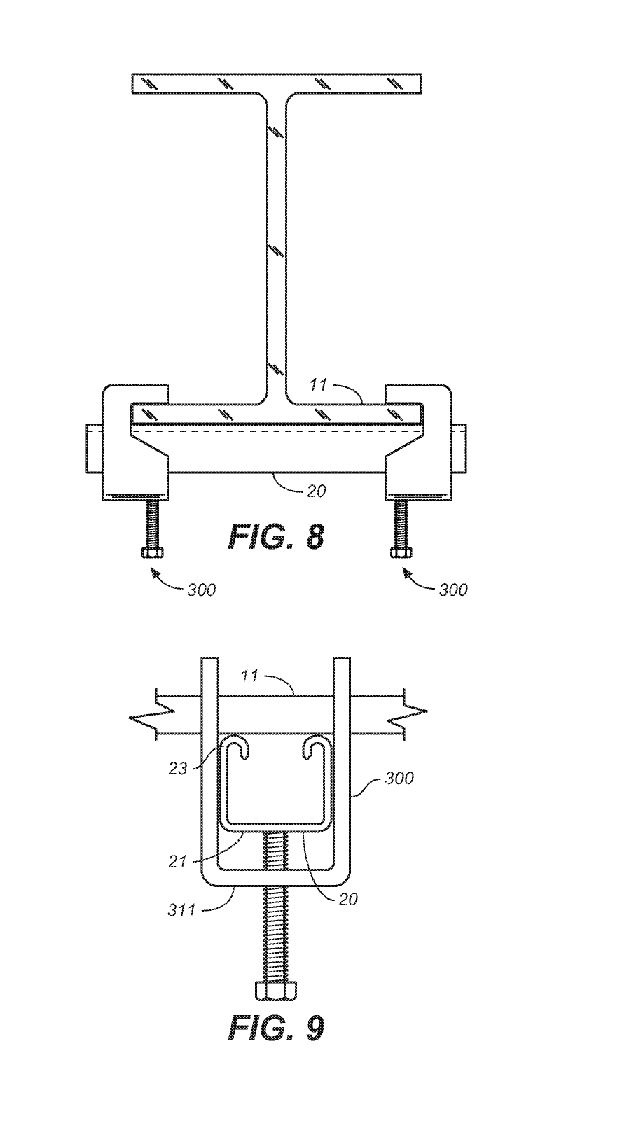

FIGS. 8 and 9 are a side and back view, respectively, of a second configuration for using a clamp, in which strut channel 20 is oriented with back 21 facing towards bottom 311. In this configuration, threaded element 301 is tightened against an outer surface of back 21, and front 23 is forced against flange 11, as shown in FIG. 9.

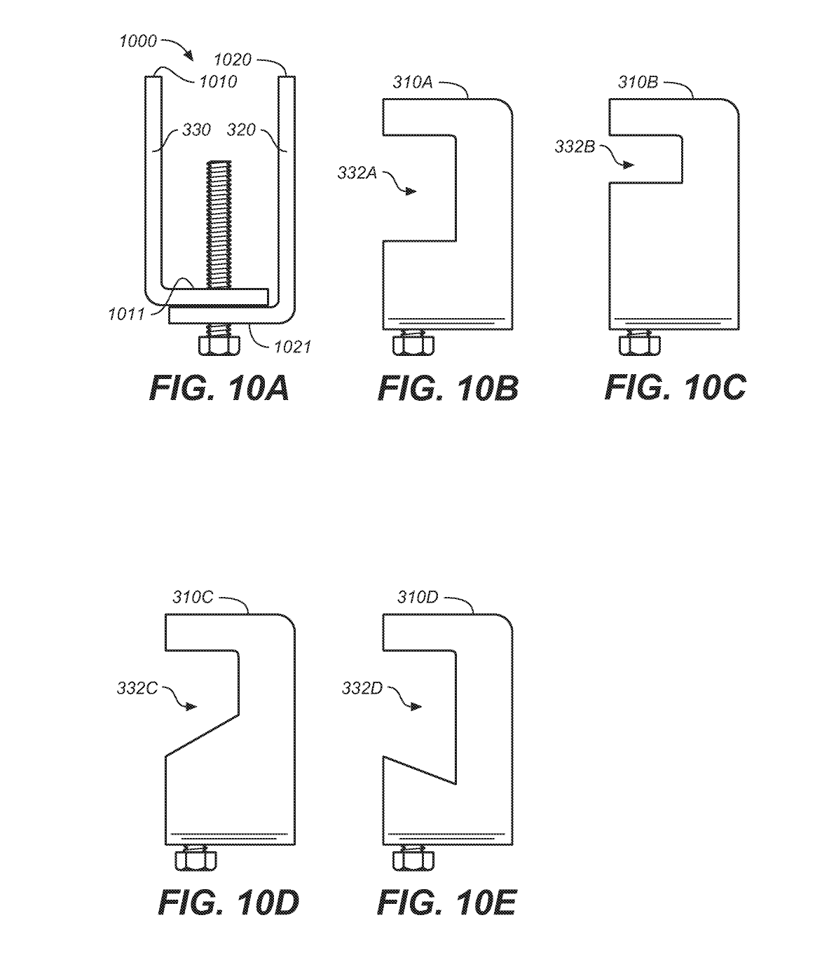

FIG. 10A is a back view of a first alternative clamp body 1000, which is generally similar to clamp body 310, except as noted. Clamp body 1000 includes two portions—a first portion 1010 which includes side 330 and a bottom 1011 having a hole (not shown), and a second portion 1020 which includes side 320 and a bottom 1021 having a threaded hole (not shown). Portions 1010 and 1020 are aligned bottoms 1011 and 1012 overlapping, permitting a placement of threaded element 301, 600, or 700 through the threaded hole of bottom 1021 and through hole of bottom 1011. The two part configuration of clamp body 1000 allows for more flexibility in clamping components that a single part clamp body, such as clamp body 310. In one embodiment, portions 1010 and 1020 are separate pieces. In another embodiment, portions 1010 and 1020 are joined together as shown in FIG. 10A.

FIGS. 10B, 10C, 10D, and 10E illustrate first, second, third, and fourth alternative notches, respectively in the sides of a clamp body 310. Specifically, FIG. 10B shows an alternative clamp body 310A having a notch 332A, FIG. 10C shows an alternative clamp body 310C having a notch 332C, FIG. 10D shows an alternative clamp body 310D having a notch 332D, and FIG. 10E shows an alternative clamp body 310E having a notch 332E. Each of the notches in FIGS. 10B through 10D has a matching notch with a mirror image shape on the opposite clamp side. Further the various notch shapes may be included on other clamp bodies, such as clamp body 1000. The various notches may be used to provide clamping of different sides parts. Thus, for example, notch 332A allows for a thicker flange than does notch 332B, and notches 332C and 332D allow for tapered flanges.

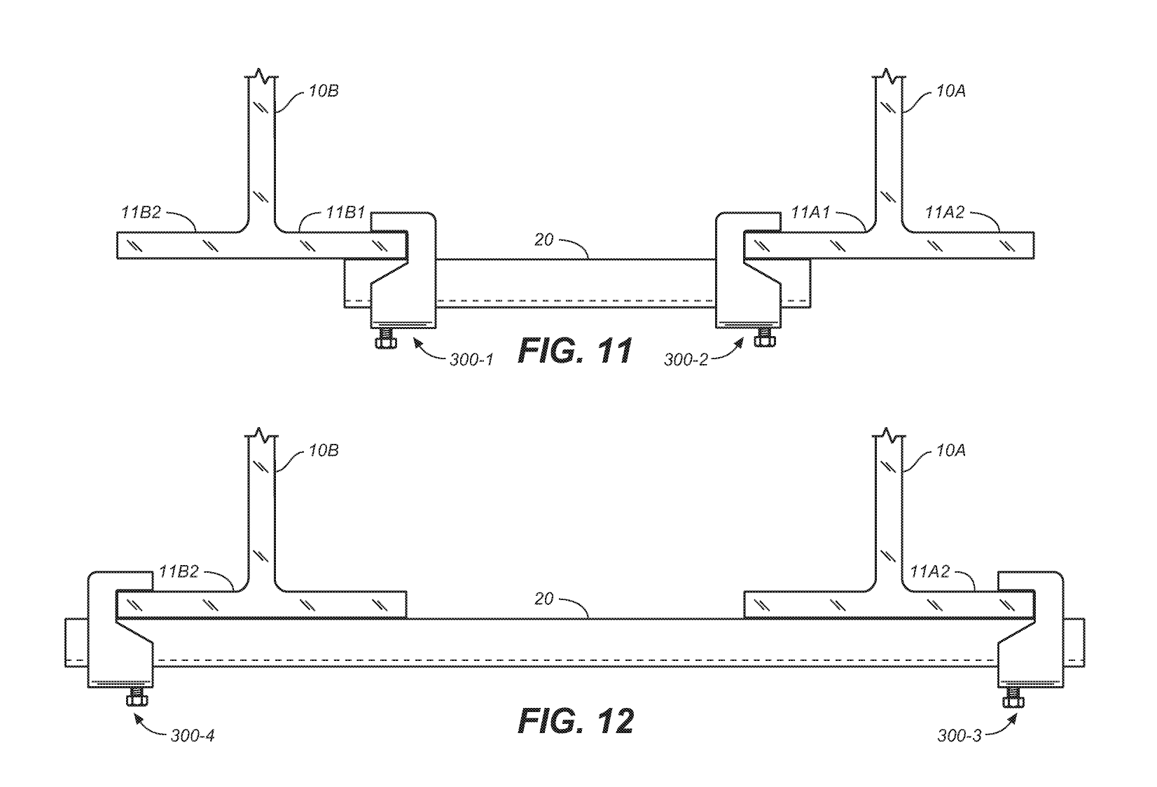

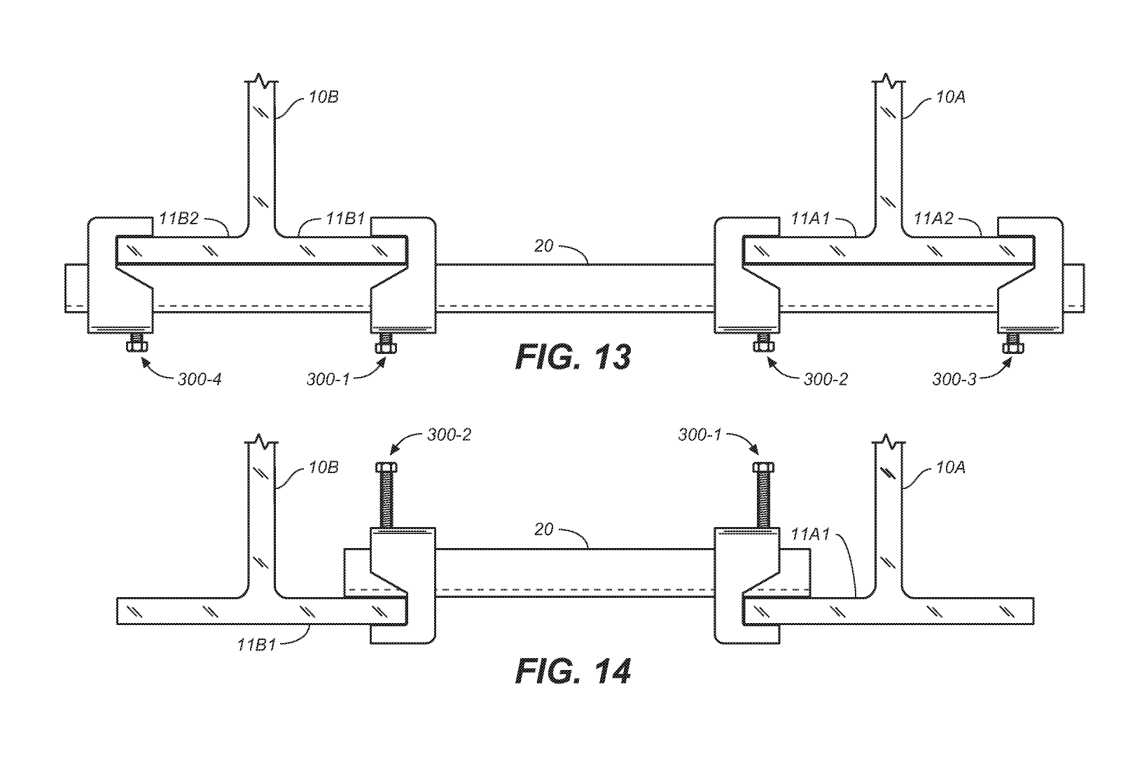

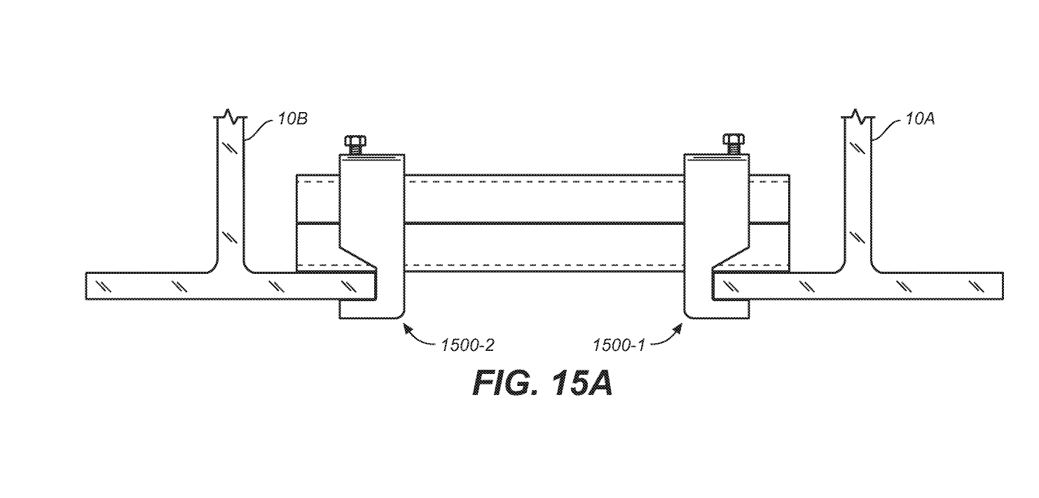

FIGS. 11-13 illustrate alternative embodiments for clamping to a pair of parallel I-beams, 10A and 10B, where I-beam 10A has a first flange 11A-1 which faces I-beam 10B and a second flange 11A-2 that faces away from I-beam 10B. I-beam 10B has a first flange 11B-1 which faces I-beam 10A and a second flange 11B-2 that faces away from I-beam 10A.

FIGS. 11-13 illustrate various ways of attaching strut channel 20 to pair of I-beams 10A and 10B with various amounts of strength and stability. As shown in FIG. 11, strut channel 20 is perpendicular to I-beams 10A and 10B, and is attached to flange 11A-1 with a clamp 300-1 and to flange 11B-1 with a clamp 300-2. As shown in FIG. 12, strut channel 20 is perpendicular to I-beams 10A and 10B, and is attached to flange 11A-2 with a clamp 300-3 and to flange 11B-2 with a second clamp 300-4. As shown in FIG. 12, strut channel 20 is perpendicular to I-beams 10A and 10B, and is attached to flange 11A-1 with a clamp 300-1, to flange 11A-2 with a clamp 300-3, to flange 11B-1 with a clamp 300-2 and to flange 11B-2 with a second clamp 300-4.

FIG. 14 illustrates and embodiment of the use of the inventive clamp. In this embodiment, strut channel 20 is placed on top of a pair of I-beam flanges 11A-1 and 11B-1, and the clamps 300-1 and 300-2 are placed with the clamping surfaces contacting the bottom flange surfaces.

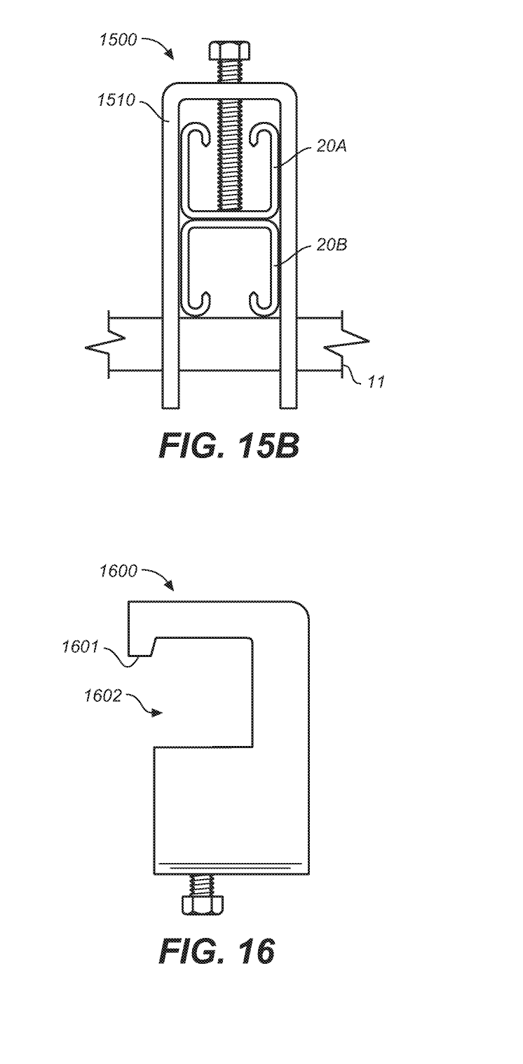

FIGS. 15A and 15B are a side view and back view, respectively, which illustrates an alternative embodiment of a clamp 1500 having a clamp body 1510 for accepting a pair of strut channels 20A, 20B, within the clamp body. Clamp body 1510 is generally similar to clamp body 310 or 1510 except as noted. Clamp body 1510 is long enough to accept the pair of strut channels 20A and 20B.

FIG. 16 is a side view of another alternative clamp 1600 which includes a lip 1601 at the top of notch 1602. Clamp 1600, which is generally similar to the other clamp embodiments described herein, is well suited to securing a strut channel or elements in the clamp, as described subsequently.

The clamps of the present invention have great utility and maybe used in various combinations to form complicated structures.

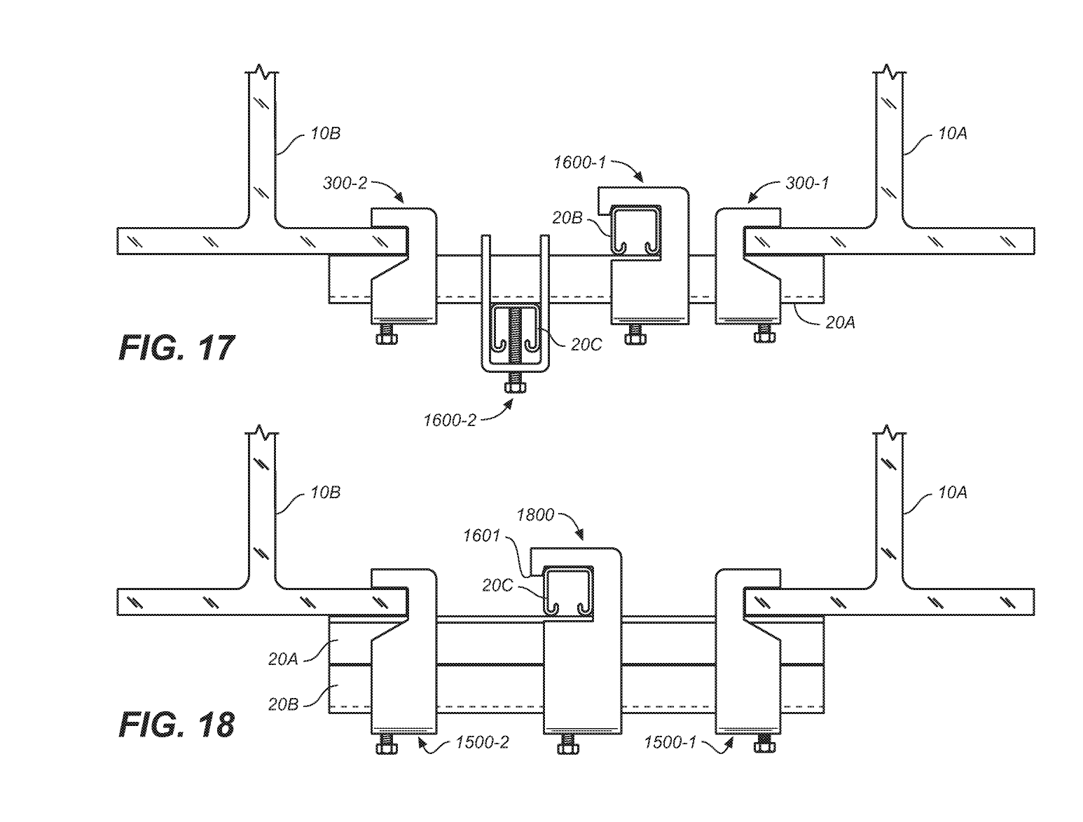

FIG. 17 is side view of various, non-limiting, uses and combinations of the inventive clamps. A first I-beam 10A and second I-beam lOB support a first strut channel 20A with a first clamp 300-1 and a second clamp 300-1, similar to what is illustrated in FIG. 11. A first clamp 1600-1 and a second clamp 1600-2, generally similar to clamps 1600 are used to attach a second strut channel 20B and third strut channel 20C, respectively, perpendicular to the first strut channel 20A, where the second strut channel is placed on top of the first strut channel and where the third strut channel is suspended below the first strut channel.

FIG. 18 is side view of other various, non-limiting, uses and combinations of the inventive clamps. A first I-beam 10A and second I-beam lOB support a pair of strut channels 20A and 20B using a first clamp 1500-1 and a second clamp 1500-2. This configure is similar to that of FIG. 15A, but where the strut channels are suspended below the I-beams. A clamp 1800 is used to attach a third strut channel 20B perpendicular to strut channels 20A and 20B. Clamp 1800 includes features similar to clamp 1500, in that it may accept a pair of channels in the clamp body, and to clamp 1600, in that it includes a lip 1601 to restrain a strut channel.

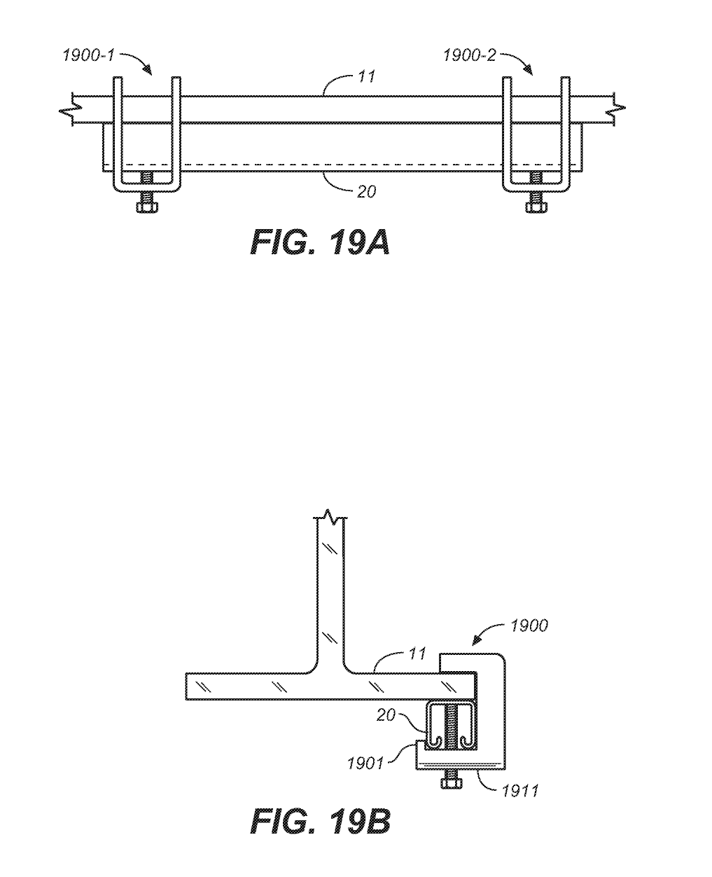

FIGS. 19A and 19B are a side view and end view, respectively, of yet another configuration of the inventive clamps. In this embodiment, strut channel 20 is attached along the length of flange 11. A clamp 1900 is provided which is adapted to receive the strut channel near a bottom 1901 of the clamp, with a lip 1901 along a bottom 1900 for restraining the strut channel, and for receiving a flange at the distal end of the clamp.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

What is claimed is:

1. A method of clamping one or more parallel strut channels to an element with a clamp, where the element is a rigid element having a first element side and a second element side parallel to the first element side, and where the clamp includes a clamp bottom at a proximal end of the clamp, where the clamp bottom includes a threaded aperture sized to accept a threaded element having a head at a proximal end for tightening the threaded element and a surface at the distal end, a first clamp side extending from the clamp bottom to a distal end of the clamp, and a second clamp side extending from the clamp bottom to the distal end, where the first clamp side and the second clamp side are planar and parallel with a spacing, where the first clamp side has a first notch with a first clamp surface through the thickness of the first side, where the second clamp side has a second notch with a second clamp surface through the thickness of the second clamp side, and the first clamp surface and the second clamp surface are coplanar and parallel to the bottom, said method comprising:
accepting the one or more parallel strut channels in the clamp, where the one or more parallel strut channels are positioned against the clamp bottom and between the first clamp side and the second clamp side;
placing the first clamp surface and the second clamp surface against the first element side with the accepted one or more parallel strut channels adjacent the second element side; and
tightening the threaded element such that the distal end of the threaded element contacts the accepted one or more parallel strut channels,
such that the clamp provides a force on the one or more parallel strut channels to clamp the one or more parallel strut channels to the element.

2. The method of claim 1, where the one or more parallel strut channels is one strut channel having a rectangular cross section with a strut back, a pair of strut sides and a strut top having an opening to an interior of the one strut channel, where the strut back has an inner surface facing the interior of the one strut channel, and where said placing the one strut channel in the clamp includes placing the strut back against the clamp bottom, and where said tightening the threaded element provides a force to the inner surface of the strut back.

3. The method of claim 1, where the one or more parallel strut channels is one strut channel having a rectangular cross section with a strut back, a pair of strut sides and a strut top, and where said placing the one strut channel in the clamp includes placing the strut top against the clamp bottom, and where said tightening the threaded element provides a force to an outer surface of the strut back.

4. The method of claim 1, where the distal end of the threaded element includes an enlarged surface area to provide the force on the one or more parallel strut channels when the threaded element is tightened.

5. The method of claim 1, where the distal end of the threaded element contacts a separate element to provide the force on the one or more parallel strut channels when the threaded element is tightened.

6. The method of claim 1, where the element is a flange.

7. The method of claim 1, where the element is the flange of a beam.

8. The method of claim 1, where the element is an element with a rectangular shaped cross-section.

9. The method of claim 1, where the element is an element with a square shaped cross-section.

10. The method of claim 1, where the element is an angle shaped member.

11. The method of claim 1, where at least one strut channel of the one or more parallel strut channels has a rectangular cross-sectional shape.

12. The method of claim 11, where said rectangular cross-sectional shape has a width of 3/16 inches, 1¼ inches, or 1⅝ inches.

13. The method of claim 1, where at least one strut channel of the one or more parallel strut channels has a square cross-sectional shape.

14. The method of claim 13, where said square cross-sectional shape has a dimension of 3/16 inches on a side, 1¼ inches on a side, or 1⅝ inches on a side.

15. The method of claim 1, where the one or more parallel strut channels is one strut channel.

16. The method of claim 1, where the one or more parallel strut channels is two strut channels including a first strut channel and a second strut channel.

17. The method of claim 16, where said accepting the two strut channels in the clamp accepts the first strut channel against the clamp bottom and between the first clamp side and the second clamp side, and accepts the second strut channel against the first strut channel and between the first clamp side and the second clamp side, and where said tightening the threaded element tightens such that the distal end of the threaded element provides a force to the second strut channel.

18. The method of claim 1, where the element has an edge between the first element side and the second element side, where the one or more parallel strut channels have a longitudinal axis, and wherein said placing places the first notch and the second notch against the edge such that the accepted one or more parallel strut channels are perpendicular to the edge of the element.

19. The method of claim 1, where threaded element is a rod or a bolt.

20. The method of claim 1, where the distance between the first clamp side and the second clamp side is equal or greater than 1¼ inches.

21. The method of claim 20, where the distance between the first clamp side and the second clamp side is 1¼ inches or is 1⅝ inches.
